(19) United States
(12) Patent Application Publication
(10) Pub. No.: US 2019/0057431 A1
(43) Pub. Date: Feb. 21, 2019

(54) TRANSACTION MONITORING SYSTEM AND METHOD

(71) Applicant: Mastercard International Incorporated, Purchase, NY (US)

(72) Inventor: Ravi Pareek, Pune (IN)

(21) Appl. No.: 16/039,810

(22) Filed: Jul. 19, 2018

(30) Foreign Application Priority Data
Aug. 15, 2017 (SG) 10201706674Y

(51) Int. Cl. G06Q 30/06; G06Q 30/02; G06Q 20/10; G06Q 20/32; G01C 21/34

(52) U.S. Cl. CPC G06Q 30/0631; G06Q 30/0641; G06Q 30/0639; G01C 21/343; G06Q 20/102; G06Q 20/32; G06Q 30/0224

(57) ABSTRACT

A method for monitoring transactions and providing recommendations, the method including, in one or more electronic processing devices, receiving transaction data indicative of transaction details regarding a transaction between a user and a merchant, the transaction details being indicative of at least one of a merchant identity of the merchant, a merchant type associated with the merchant, an item associated with the transaction, and an item type associated with the transaction, retrieving at least one recommendation from relationship data using the transaction details, the relationship data being indicative of a plurality of recommendations, each recommendation being related to at least one of at least one merchant identity, at least one merchant type, at least one item type, and at least one item, and causing a recommendation indication indicative of at least one recommendation to be displayed to the user, thereby allowing the user to selectively perform at least one transaction.

### CROSS-REFERENCE TO RELATED APPLICATION

This application is a U.S. National Stage filing under 35 U.S.C. § 119, based on and claiming benefits of and priority to Singapore Patent Application No. 10201706674Y filed on Aug. 15, 2017. The entire disclosure of the above application is incorporated herein by reference for all purposes.

### BACKGROUND OF THE INVENTION

The present invention relates to a system and method for monitoring transactions, and in one particular example, to a system and method for monitoring transactions to provide recommendations to users and/or merchants.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Geotargeting is a form of geomarketing which aims to deliver appropriate content to consumers based upon their location. A common use of geotargeting is found in online and display advertising where advertising is selectively displayed according to a consumer's location. However, this type of advertising has a number of drawbacks. For example, a consumer's location may not be sufficient to select relevant advertising content, thus wasting advertising revenue on targeting the wrong consumers.

A number of other methods and systems exist which attempt to use additional information derived from user activity. However, each of these suffer from one or more disadvantages in failing to optimise the consumer experience.

The present invention seeks to ameliorate one or more of the problems associated with the prior art.

### SUMMARY OF THE PRESENT INVENTION

In a first broad form the present invention seeks to provide a method for monitoring user transactions and providing recommendations, the method including, in one or more electronic processing devices:

a) receiving, at a relationship assessment engine, transaction data indicative of transaction details regarding a transaction between a user and a merchant, the transaction details being indicative of at least one of:

i) a merchant identity of the merchant;

ii) a merchant type associated with the merchant;

iii) an item associated with the transaction; and,

iv) an item type associated with the transaction;

b) retrieving, from the relationship assessment engine, at least one recommendation from relationship data using the transaction details, the relationship data being indicative of a plurality of recommendations, each recommendation being related to at least one of:

i) at least one merchant identity;

ii) at least one merchant type;

iii) at least one item type; and,

iv) at least one item; and,

c) causing, at a user device, a recommendation indication indicative of at least one recommendation to be displayed to the user, thereby allowing the user to selectively perform at least one transaction relating to the at least one recommendation,
wherein the relationship data is in a form of either a map of linkages or a look-up table.

In a second broad form, the present invention provides a system for monitoring user transactions and providing recommendations, the system including one or more electronic processing devices that:

a) receives, at a relationship assessment engine, a bill indicative of transaction details regarding a transaction between a user and a merchant, the bill being indicative of at least one of:

i) a merchant identity of the merchant;

ii) a merchant type associated with the merchant;

iii) an item associated with the transaction; and,

iv) an item type associated with the transaction;

b) retrieves, at the relationship assessment engine, at least one recommendation from relationship data using the transaction details, the relationship data being indicative of a plurality of recommendations, each recommendation being related to at least one of:

i) at least one merchant identity;

ii) at least one merchant type;

iii) at least one item type; and,

iv) at least one item; and,

c) causes, at a user device an indication of the at least one recommendation to be displayed to the user, thereby allowing the user to selectively perform at least one transaction relating to the at least one recommendation,
wherein the relationship data is in a form of either a map of linkages or a look-up table.

### BRIEF DESCRIPTION OF THE DRAWINGS

An example of the present invention will now be described with reference to the accompanying drawings, in which: —

FIG. 1 is a flowchart of a first example of a method for monitoring user transactions and providing recommendations;

FIG. 2 is a schematic diagram of an example of a system for monitoring user transactions and providing recommendations;

FIG. 3 is a schematic diagram of an example of a processing system;

FIG. 4 is a specific example of a transaction terminal;

FIG. 5 is a schematic diagram of an example of a user device;

FIGS. 6A and 6B is a flowchart of a further example of a method for monitoring user transactions and providing recommendations;

FIG. 7 is a flowchart of a further example of a method for monitoring user transactions and providing recommendations; and,

FIG. 8 is a flowchart of a further example of a method for monitoring user transactions and providing recommendations.

### DETAILED DESCRIPTION

The present invention operates to monitor transactions in order to provide recommendations to user, for example, regarding related merchants, products, services and/or types thereof. In this regard, a user may then utilise the recommendation to initiate a booking, payment or pre-payment relating the recommendation(s), and/or to compile an itinerary from a number of recommendations. In particular, the recommendations are retrieved using relationship data, which in some examples includes predetermined relationships between merchants, merchant types, or items and item types, and in other examples is dynamically updated using transaction details.

Generally, transaction details regarding a transaction between a user and a merchant are processed. This typically involves receiving the transaction data from a transaction device via a communications network. Consequently, at least one recommendation based on relationship data using the transaction details is obtained. In some examples, the relationship data may define dependencies and/or ordering and/or links among merchants, types of merchants, items or types of items. Subsequently, an indication of the recommendation(s) is displayed to the user, thereby allowing the user to selectively perform at least one transaction relating to the at least one recommendation. Accordingly, the above described monitoring processing operates to monitor transactions in order to provide recommendations to user, for example, regarding related merchants, products, services and/or types thereof. Correspondingly, a user may then utilise the recommendation to initiate a booking, payment or pre-payment relating the recommendation(s), and/or to compile an itinerary from a number of recommendations.

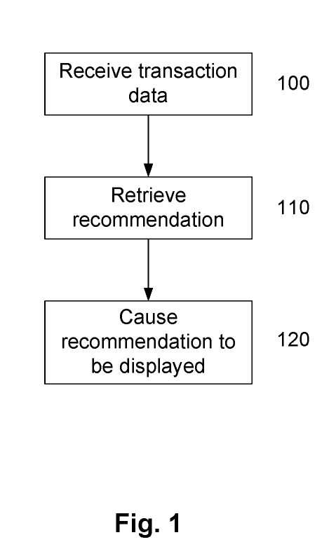

A general example of a method for monitoring user transactions and providing recommendations will now be described with reference to FIG. 1. Further details will be provided for specific embodiments in subsequent paragraphs.

For the purpose of these examples, it is assumed that the transactions are performed and monitored at least in part utilising one or more electronic processing device(s) that are typically part of one or more processing systems, such as one or more servers, and may form part of a payment network backend, or similar. For the following description reference will generally be made to a single electronic processing device, but it will be appreciated that the functionality performed by the electronic processing device could in practice be distributed across multiple processing devices and associated systems, and reference to a single device is not intended to be limiting.

The electronic processing device can be in communication with a one or more transaction devices, such as a merchant or user device and/or a merchant terminal associated with a merchant. The user device can be a suitably programmed mobile communications device, such as a mobile phone, tablet, a suitably programmed computer system, or the like, whilst the merchant terminal can be any form of device capable of being used in a transaction and could include a POS (Point of Sales) terminal, payment terminal, a suitably enabled merchant user device, for example a tablet incorporating a payment application and optional card scanning capabilities, or the like. It will however be appreciated that a wide range of different devices could be used and the examples given are for the purpose of illustration only.

Additionally, for the purposes of these examples, reference to an “item” is not intended to be limiting and may include one or more products and/or one or more services.

In this example, at step 100 the one or more electronic processing devices receive transaction data indicative of transaction details regarding a transaction between a user and a merchant. In this regard, the transaction details are indicative of one or more of a merchant identity of the merchant, a merchant type associated with the merchant, an item associated with the transaction, and an item type associated with the transaction. This can be achieved in any one of a number of manners but typically involves receiving the transaction data from a transaction device via a communications network. This may occur either during or after the transaction is performed. The transaction data can form part of the normal data communication between the user device or transaction terminal and, for example, a payment network depending upon the preferred implementation.

At step 110 the electronic processing device retrieves at least one recommendation from relationship data (using the transaction details) from a relationship assessment engine. In this respect, the relationship data is indicative of a plurality of recommendations, each recommendation being related to any one or more of one or more merchant identities, one or more merchant types, one or more item types, and one or more items. In some examples, the relationship data may define dependencies and/or ordering and/or links among merchants, types of merchants, items or types of items. The recommendation is indicative of one or more merchant identities, one or more merchant types, one or more item types, and/or one or more items. Thus, recommendations may reflect suitable merchants, products and/or services and/or types thereof. This can be beneficial, such as in situations where a user may wish to be prompted, or may otherwise forget, to book appropriate onward products or services. For example, a user booking an international flight may not be aware of the particular ground transportation available to them upon arrival. By providing recommendations of transport, the user can organise their entire journey without the need for extensive and time-consuming research.

The relationship data is indicative of a merchant type and/or an item type, and the relationship assessment engine determines the recommendation by determining a plurality of merchants using the merchant type and/or determining a plurality of items using the item type. For example, this allows the relationship data to define relationships between broader categories or classifications of merchants/items, such as restaurants, transport, airline, dessert, or indeed any suitable type. Thus, a plurality of merchants or items can be determined which identify with the determined types. Moreover, this can in some examples simplify the number of relationships which are included in the relationship data as numerous individual relationships between each combination of individual merchant or item may not be required.

Additionally or alternatively, the relationship(s) may be determined using any suitable method, such as any one or more of previous transaction details, reference relationships, merchant input commands, and user input commands. For example, previous transaction details may be used to determine relationships between user transactions and hence between items or merchants or types thereof. Indeed, in some examples, the electronic processing device updates the relationship data using the transaction details. However, this is not essential and in other examples, reference relationships may be used, for example, from a store. These may be defined by, for example, a user such as an administrator. In other examples, the relationships may be determined using user or merchant input commands. Thus, a merchant may define their items are being dependent on a particular preceding product or service, such as, a merchandising merchant being dependent upon theatre, concert or sporting sales. This can be advantageous, as it allows a merchant to customise their marketing and advertising to users via the merchant-defined relationships.

In examples where the relationship data is updated using transaction details, this can provide a particular benefit in terms of using the relationship data to motivate advertising or marketing campaigns, alterations to a merchant's items, or the like. For example, the relationship data could provide insights into user behaviour which inform a merchant that it may be beneficial to add options to their menu. In this regard, the relationship data may reflect that many users consume ice-cream after visiting a burger merchant, thus the burger merchant may wish to include ice-creams on their menu in future.

In a further example, the electronic processing device determines location data indicative of a location of at least one of the user and the merchant, and determines the recommendation(s) using the location data. Thus, for example, the recommendation provided to the user accounts for the location of the merchant in order to increase the relevance of the recommendation. Thus, the user may have purchased a main meal in a geographic area, and the recommendation includes nearby merchants offering desserts. Additionally or alternatively, the user may have completed a theatre booking with a theatre company merchant, and the recommendation includes after-show restaurants proximal to the theatre company. However, this is not essential, and in other examples recommendations may be determined using location data indicative of any other suitable location associated with the transaction. For example, following an airline booking, recommendations may be made relating to the destination of the flight.

In one example, the electronic processing device determines a search vicinity using the location data, and determines the recommendation at least partially using the search vicinity. The search vicinity may be determined in any suitable manner, for example, using a predetermined distance, area, or other geometric measure, or indeed any other suitable measure which, for example, when applied to the location data results in a search vicinity. For example, a search vicinity may be determined as within a predetermined number of kilometres of the location indicated by the location data. However, this is not essential, and in other examples the search vicinity may be determined using population density or another demographic measure. For example, the search vicinity may be defined by selecting an area surrounding the location data which includes a predetermined population, or population density, or other population metric. This is beneficial as, in some examples, it allows the recommendations to be further constrained to ensure higher relevancy for the user.

In one particular example, the electronic processing device determines the recommendation by selecting a plurality of merchants using the search vicinity and a merchant type defined in the relationship data. Thus, for example, the recommendation may include selecting a number of ‘dessert’ merchants (merchant type) within a few hundred metres of the location (search vicinity). Advantageously, this provides a user with a choice of merchants within a constrained vicinity, and accordingly the user can then make a merchant selection based upon the recommendation provided. This saves the user time and effort in searching for relevant merchants, and manually ascertaining whether the merchant falls within a relevant search vicinity.

In a further example, the relationship data is indicative of sequences of relationships. Moreover, in some examples, the sequences may define, or be indicative, of a dependency and/or order and/or link. This may be achieved in any suitable manner, and in some examples includes the sequences can be defined by merchant type such as ‘starter’ merchants precede ‘main course’ merchants which in turn precede ‘dessert’ merchants, or ‘airline’ merchants are related to ‘transportation’ merchants which are related to ‘accommodation’ merchants. However, sequences may be defined in any suitable manner, for example, using merchants, items or item types. In this regard, item types may include ‘flights’ are related to ‘taxis’ which in turn are related to ‘hotels’, and the like. This is particularly beneficial as the sequence of relationships allows recommendations to be selected according to numerous onward activities or products which may be of interest to the user. This saves the user time, whilst also ensuring the user is adequately prepared.

In another example, the recommendation indication is indicative of a sequence of recommendations. For example, the recommendation indication may be indicative of a plurality of merchants offering ‘main courses’ followed by a plurality of merchants offering ‘desserts’ and the like. Thus, the user is presented with a sequence of recommendations which relate to potential onward activities or products which may be of interest.

Thus, the relationship data can be in a form of, for example, a map of linkages depicting ties between a plurality of entities, a look-up table of ties between a plurality of entities and so forth. For example, the relationship data should be indicative of an ice-cream restaurant offering products typically ordered after a meal, or a taxi service typically being booked following an airline booking, train booking, or the like. Moreover, in some examples merchant or item types may be used to define relationships between higher level categories of merchants or items, such as desserts following main courses, or transportation services following performance or restaurant services.

At step 120, the electronic processing device causes an indication of the recommendation(s) to be displayed to the user, thereby allowing the user to selectively perform at least one transaction relating to the at least one recommendation. The indication can be in any appropriate form and can be provided to the user through any appropriate mechanism, such as sending a message to a transaction device, such as a user device or transaction terminal such as a merchant terminal.

Accordingly, the above described monitoring processing operates to monitor transactions in order to provide recommendations to user, for example, regarding related merchants, products, services and/or types thereof. In this regard, a user may then utilise the recommendation to initiate a booking, payment or pre-payment relating the recommendation(s), and/or to compile an itinerary from a number of recommendations. In particular, the recommendations are retrieved using relationship data, which in some examples includes predetermined relationships between merchants, merchant types, or items and item types, and in other examples is dynamically updated using transaction details.

Thus, the retrieval of recommendations is simplified using relationship data which is indicative of relationships, for example, ordering volume, transaction amount, transaction type, transaction rate, dependencies and so forth. This is particularly beneficial, as it typically negates the need for use of algorithms, e.g. pattern classification, in order to provide recommendations based upon historical transactions.

The above described example is also beneficial as it provides increased relevancy in the recommendations provided. For example, advertising and marketing by recommended merchants can be specifically tailored to each user based upon their real-time transactions and pre-determined onward relationships, thus ensuring advertising budgets are not wasted.

Additionally, the increase relevancy of the recommendations saves the user from expending time by manually searching for options. Moreover, in some examples, the user can initiate a single booking or payment for multiple recommendations, saving considerable time by obviating the need to perform multiple separate bookings/payments.

A number of further features will now be described.

In one example, the electronic processing device generates a recommendation message, the recommendation message being indicative of the recommendation(s), and provides the recommendation message to a transaction device. This may be achieved in any suitable manner, and typically includes providing the recommendation message via a communications network.

As discussed above, the transaction device may include any suitable device such as a user device or a transaction terminal, for example, a point of sale (POS) device, ATM, or the like. In this regard, the transaction device is responsive to the recommendation message to display a recommendation indication indicative of at least one recommendation. In one example, this is achieved via a display of the transaction device, such as a screen of a smartphone or POS device. Additionally, the transaction device determines user acceptance of a recommendation in accordance with user input commands. For example, a user may use a keyboard or touchscreen of, or associated with, the transaction device in order to accept the recommendation. The transaction device generates an acceptance message, and provides the acceptance message to the one or more electronic processing devices, for example, via a communications network.

Additionally, the electronic processing device receives the acceptance message. In accordance with the acceptance message, the electronic processing device causes a booking to be made, causes the recommendation to be acquired, and/or performs a transaction relating to the recommendation.

Thus the electronic processing device typically interacts with the transaction device in order to display recommendation indications for the user, and perform actions based upon user selection. This is advantageous, for example, as it allows a user to be presented with relevant options which they can subsequently select, without the need for user initiated research and searching.

In a further example, the electronic processing device causes the booking to be made by providing a booking notification indicative of the booking to a merchant device of a merchant associated with the booking. The booking notification may be provided in any suitable manner, for example, via a communications network. In this regard, the merchant associated with the recommendation may, for example, use the booking notification in order to update their booking or reservation system to reflect the details of the booking. This is advantageous for the user in terms of being able to quickly and efficiently make onward reservations, and for the merchant in terms of targeting their marketing to users more likely to require their products/services.

The transaction device of the examples herein may include any one of a user device and a transaction terminal. For example, recommendation indications may be displayed on a user's smartphone, tablet, or the like, or may be displayed on a POS device or ATM which, for example, is associated with the merchant and optionally which has processed the transaction. Accordingly, the merchant device may include the transaction device or transaction terminal, however this is not essential. In other examples, a merchant may be associated with a separate merchant device and transaction terminal, such as where a merchant maintains a reservation system on a device separate from their POS device for accepting payments. Moreover, in some examples, the user device may also be used in payment processing, for example, a mobile payment application, digital wallet, or the like provided on a smartphone.

A merchant type and/or item type may be determined in any suitable manner, and in one example can be determined by the merchant and/or a system administrator and/or a user. For example, a merchant may input or select their associated merchant type, item(s), and/or item type(s) using a merchant terminal, the merchant terminal providing the information to the electronic processing device. However, this is not essential and in other examples a system administrator may determine the merchant and item types. Alternatively, one or more merchant type(s) and/or item type(s) may be determined by the electronic processing device based at least partially upon previous transaction data or relationship data, for example, using classification algorithms.

In addition, the transaction device determines acceptance of a plurality of recommendations in the sequence of recommendations in accordance with user input commands. For example, the user may select one of more of the sequence of recommendations using a touchscreen or display of the transaction device. The transaction device generates one or more acceptance messages indicative of a sequence of acceptances. In addition, the transaction device provides the one or more acceptance messages to the electronic processing device, the electronic processing device being responsive to the one or more acceptance messages to cause a sequence of bookings to be made and/or cause at least one of the sequence of recommendations to be acquired and/or perform at least one transaction relating to the sequence of acceptances. Thus, the user is in some examples able to select a sequence of activities/products or a range of onward activities by evaluating and selecting from the sequence of recommendations presented.

In a further example, the electronic processing device generates an itinerary indicative of a sequence of acceptances and causes an indication of the itinerary to be displayed to the user. This can be particularly beneficial as it allows a user to build and extend an itinerary of merchants or items or types thereof based upon acceptance of recommendations which are presented to them. Thus, the itinerary may include related activities such as flight and taxi, related merchants such as breakfast and coffee merchants, dinner and bars/clubs, or the like. Moreover, collating the acceptances into an itinerary allows the user to retain a central repository for their activities or products, and potentially to make one payment for some/all of the acceptances in the itinerary, and this is discussed further below.

In a further example, the electronic processing device causes a payment to be performed in respect of multiple acceptances in accordance with one or more acceptance messages. Thus, in some examples a payment may correspond to multiple acceptances which is advantageous in saving the user time and effort in making separate payments for each acceptance. This may be achieved in any suitable manner and may include disbursing the payment to multiple merchants, as described below. Moreover, such an arrangement is beneficial for a merchant, as they may not be directly responsible for recovering payment.

In one particular example, the multiple recommendations are associated with a number of merchants. In this regard, the electronic processing device causes an account of the user to be debited in accordance with payment details of the payment, and causes an account of each of the merchants associated with a corresponding one of the sequence of acceptances to be credited in accordance with the payment details. This may be achieved in any suitable manner, such as via a communication network, using a card reader, payment network, acquirer, online payment applications, digital wallets, or the like. As methods and systems for debiting and crediting accounts is known it will not be detailed further here. Additionally, the electronic processing device causes an indication of an outcome of the payment to be displayed to at least one of the user and the merchants.

Optionally, the electronic processing device generates a merchant notification indicative of a recommendation, and provides the merchant notification to a merchant device of a recommended merchant associated with the recommendation. Thus, for example, the merchant may therefore be made aware that they (or their items) have been recommended to a user. The merchant device is responsive to the merchant notification to determine an offer in accordance with the recommendation, generate an offer notification, and provide an offer notification to the electronic processing device.

In this regard, the merchant device may determine the offer in any suitable manner. For example, the merchant device may determines the offer from offer data and/or displays an indication of the recommendation and determines the offer in accordance with merchant input commands. In terms of offer data, this may be provided in any suitable form, such as, with reference to predetermined offers or types of offers stored in a store, or may automatically be generated, for example, using a number of predetermined parameters. For example, the merchant notification may be used as a lookup to retrieve an offer from the store, such as, a 50% price reduction is offered if a merchant's ice-cream cones are recommended to a user.

Alternatively, by displaying an indication of the recommendation and accepting merchant input commands from, for example, a merchant or merchant representative, may at least partially enable the merchant to dynamically market and promote their items based upon real-time circumstances. For example, a merchandising merchant may be made aware of a recommendation to a user who has paid for a football game, and accordingly the merchant may wish to offer a 2 for 1 promotion on jerseys relating to the teams playing in that game.

Moreover, any suitable offer may be determined, for example, a price promotion, a tailored advertisement, or any other suitable form of promotion, marketing or advertising.

Further, the electronic processing device receives the offer notification indicative of the offer and causes an indication of the offer to be displayed to the user in accordance with the recommendation. Accordingly, the recommendations provided to the user may be accompanied by offers created by recommended merchants, for example, dynamically or using predetermined parameters. This is beneficial for the consumer, as there is no need to manually shop around for items of interest. It is also advantageous for the merchants in terms of providing relevant, targeted advertising and marketing.

In another example, the electronic processing device generates an offer message, the offer message being indicative of at least one offer, and provides the offer message to a transaction device. In this regard, the transaction device is responsive to the offer message to display an offer indication indicative of at least one offer, determine user acceptance of at least one offer in accordance with user input commands, generate an offer acceptance message, and provide the offer acceptance message to the one or more electronic processing devices. The electronic processing device further receives the offer acceptance message and notifies the merchant of the offer acceptance, thereby allowing the user to redeem the offer. In this regard, for example, the user is then able to assess and selectively accept offers from recommended merchants. Moreover, the merchants for whom an offer has been accepted are subsequently notified.

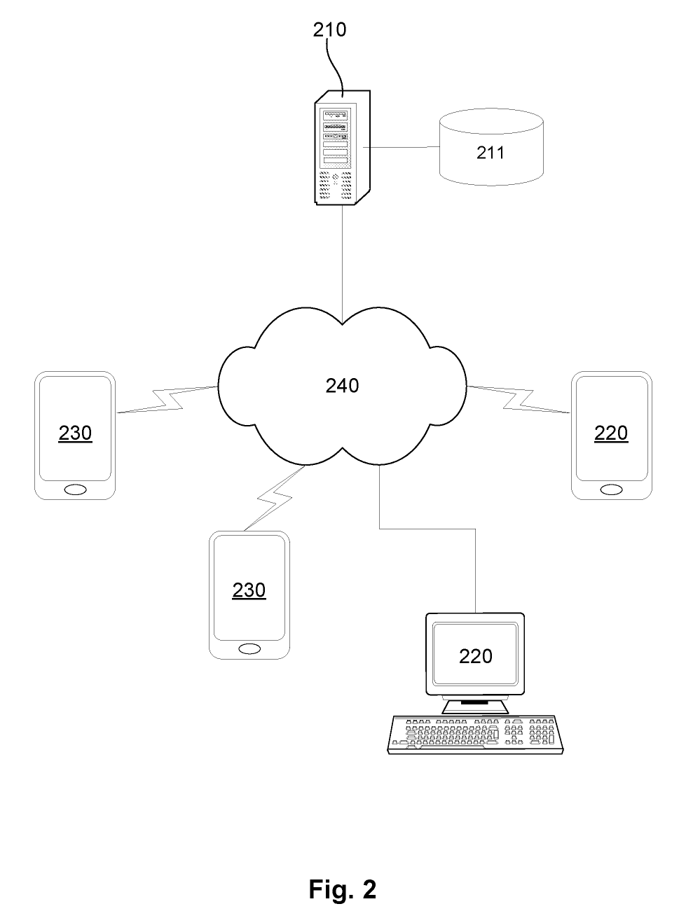

In one example, the process is performed by one or more processing systems operating as part of a distributed architecture, an example of which will now be described with reference to FIG. 2.

In this example, a number of processing systems 210 are provided coupled to one or merchant devices 220, and user devices 230, via one or more communications networks 240, such as the Internet, and/or a number of local area networks (LANs). Moreover, a transaction device for the purposes of the examples herein may include any suitable device such as a user device 230 or a transaction terminal, such as the merchant device 220. In this regard, in some examples a separate transaction terminal and merchant device 220 may correspond to the same merchant, for example, in the event the transaction terminal corresponds to a merchant's POS terminal and the merchant device 220 corresponds to their reservation system, or the like. In such instances, a user device 230 may not be included in the system. However, this is not essential.

It will be appreciated that any number of processing systems 210 and similarly any number of merchant devices 220 and user devices 230 could be provided, and the current representation is for the purpose of illustration only. The configuration of the networks 240 is also for the purpose of example only, and in practice the processing systems 210, merchant devices 220 and user devices 230 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In use, the processing system 210, is adapted to be perform various data processing tasks forming part of a transaction process, and the particular functionality will vary depending on the particular requirements. For example, the processing systems can be adapted to determine transaction details, perform authentication, perform bookings, perform payments, or cause further payment systems (not shown), such as servers of financial institutions, payment gateways or the like, to perform payments, as will be appreciated by persons skilled in the art.

Whilst the processing systems 210 are shown as single entities, it will be appreciated they could include a number of processing systems distributed over a number of geographically separate locations, for example as part of a cloud based environment. Thus, the above described arrangements are not essential and other suitable configurations could be used.

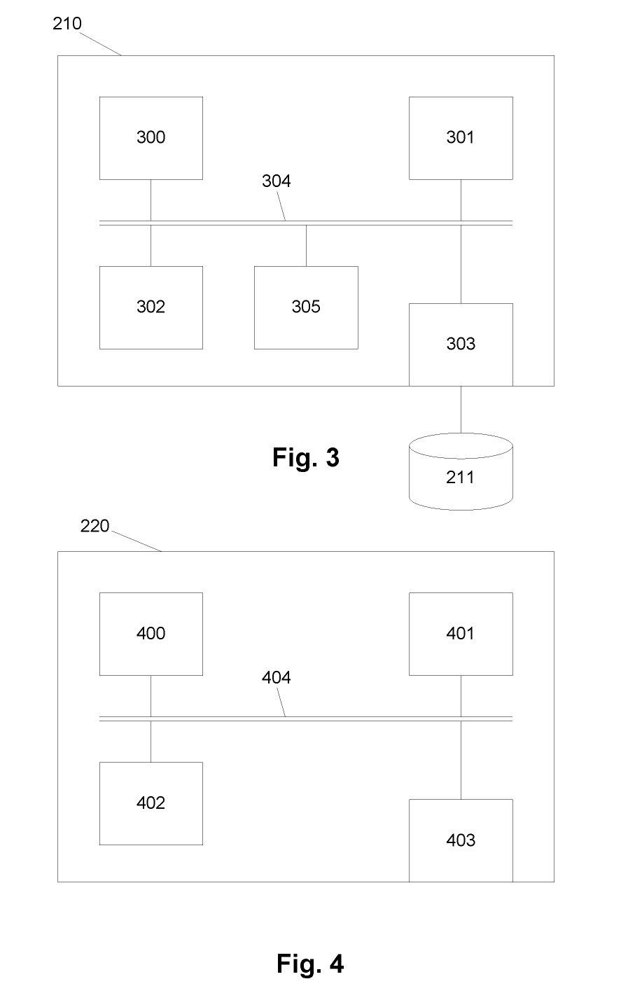

An example of a suitable processing system 210 is shown in FIG. 3. In this example, the processing system 210 includes at least one microprocessor 300, a memory 301, an optional input/output device 302, such as a keyboard and/or display, and an external interface 303, interconnected via a bus 304 as shown. In this example the external interface 303 can be utilised for connecting the processing system 210 to peripheral devices, such as the communications networks 230, databases 211, other storage devices, or the like. Although a single external interface 303 is shown, this is for the purpose of example only, and in practice multiple interfaces using various methods (eg. Ethernet, serial, USB, wireless or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like. The microprocessor 300 also includes a relationship assessment engine 305, the relationship assessment engine 305 being for processing and providing at least one recommendation from relationship data using transaction details.

Accordingly, it will be appreciated that the processing system 210 may be formed from any suitable processing system, such as a suitably programmed PC, web server, network server, or the like. In one particular example, the processing system 210 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

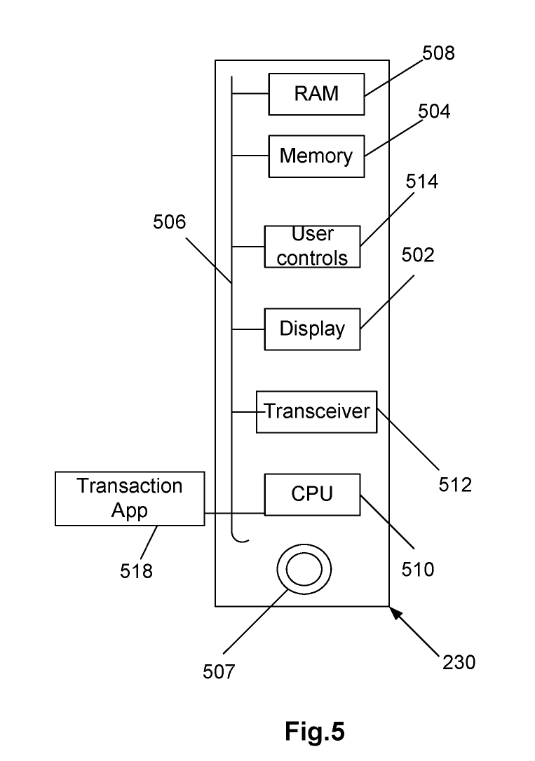

As shown in FIG. 4, in one example, the merchant device 220 includes at least one microprocessor 400, a memory 401, an input/output device 402, such as a keyboard and/or display, and an external interface 403, interconnected via a bus 404 as shown. In this example the external interface 403 can be utilised for connecting the merchant device 220 to peripheral devices, such as the communications networks 230 databases, other storage devices, payment devices such as card readers, or the like. Although a single external interface 403 is shown, this is for the purpose of example only, and in practice multiple interfaces using various methods (eg. Ethernet, serial, USB, wireless or the like) may be provided. The optional card reader can be of any suitable form and could include a magnetic card reader, or contactless reader for reading smartcards, or the like.

In use, the microprocessor 400 executes instructions in the form of applications software stored in the memory 401, and to allow communication with one of the processing systems 210.

Accordingly, it will be appreciated that the merchant devices 220 may be formed from any suitable merchant device, and could include suitably programmed PCs, Internet terminal, lap-top, or hand-held PC, POS terminals, ATMs or the like, as well as a tablet, or smart phone, with integrated or connected card reading capabilities. However, it will also be understood that the merchant devices 220 can be any electronic processing device such as a microprocessor, microchip processor, logic gate configuration, firmware optionally associated with implementing logic such as an FPGA (Field Programmable Gate Array), or any other electronic device, system or arrangement.

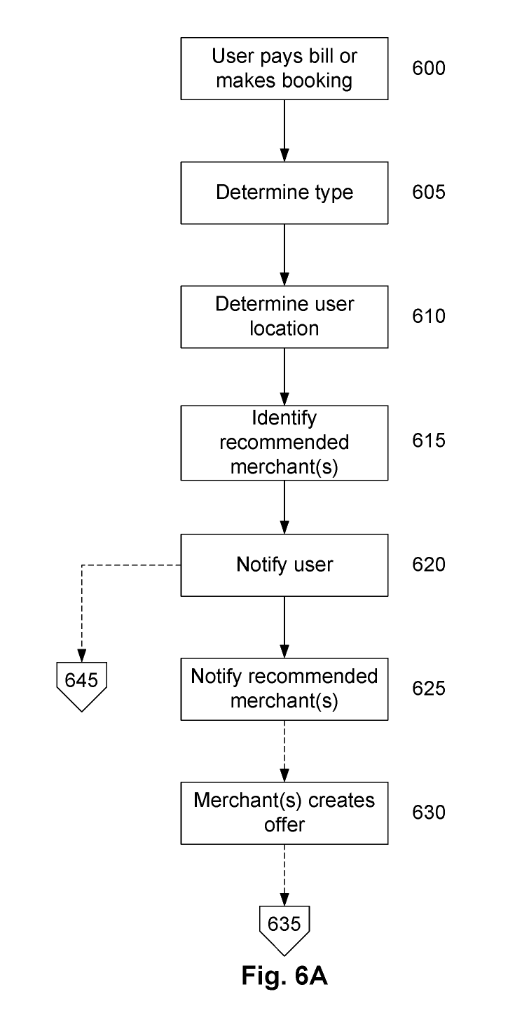

In one example, the user device 230 is a handheld computer device such as a smart phones or a PDA such as one manufactured by Apple™, LG™, HTC™, Blackberry™, or Motorola™. In one particular example, the user device 230 includes a mobile phone or a computer such as a tablet computer. An exemplary embodiment of the user device 230 is shown in FIG. 5. As shown, the user device 230 includes the following components in electronic communication via a bus 506:

1. a display 502;

2. non-volatile memory 504;

3. random access memory (“RAM”) 508;

4. N processing components 510;

5. a transceiver component 512 that includes N transceivers;

6. user controls 514;

7. microphone/speaker 507.

Although the components depicted in FIG. 5 represent physical components, FIG. 5 is not intended to be a hardware diagram; thus many of the components depicted in FIG. 5 may be realized by common constructs or distributed among additional physical components. Moreover, it is certainly contemplated that other existing and yet-to-be developed physical components and architectures may be utilized to implement the functional components described with reference to FIG. 5.

The display 502 generally operates to provide a presentation of content to a user, and may be realized by any of a variety of displays (e.g., CRT, LCD, HDMI, micro-projector and OLED displays). And in general, the non-volatile memory 504 functions to store (e.g., persistently store) data and executable code including code that is associated with the functional components of a browser component and a transaction App 518. In some embodiments, for example, the non-volatile memory 504 includes bootloader code, modem software, operating system code, file system code, and code to facilitate the implementation of one or more portions of the transaction App 518 as well as other components well known to those of ordinary skill in the art that are not depicted for simplicity.

In many implementations, the non-volatile memory 504 is realized by flash memory (e.g., NAND or ONENAND memory), but it is certainly contemplated that other memory types may be utilized as well. Although it may be possible to execute the code from the non-volatile memory 504, the executable code in the non-volatile memory 504 is typically loaded into RAM 508 and executed by one or more of the N processing components 510.

The N processing components 510 in connection with RAM 508 generally operate to execute the instructions stored in non-volatile memory 504 to effectuate the functional components. As one of ordinarily skill in the art will appreciate, the N processing components 510 may include a video processor, modem processor, DSP, graphics processing unit (GPU), and other processing components.

The transceiver component 512 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

Accordingly, it will be appreciated that the user device 230 be formed from any suitably programmed processing system and could include suitably programmed PCs, Internet terminal, lap-top, or hand-held PC, a tablet, a smart phone, or the like. However, it will also be understood that the user device 230 can be any electronic processing device such as a microprocessor, microchip processor, logic gate configuration, firmware optionally associated with implementing logic such as an FPGA (Field Programmable Gate Array), or any other electronic device, system or arrangement.

Examples of the processes for monitoring transactions will now be described in further detail. For the purpose of these examples it is assumed that one or more respective processing systems 210 are servers that provide functionality required of the electronic processing device. The servers 210 typically execute processing device software, allowing relevant actions to be performed, with actions performed by the server 210 being performed by the processor 300 in accordance with instructions stored as applications software in the memory 301 and/or input commands received from a user via the I/O device 302. It will also be assumed that actions performed by the merchant device 220, are performed by the processor 400 in accordance with instructions stored as applications software in the memory 401 and/or input commands received from a user via the I/O device 402, whilst actions performed by the user device 230 are performed by the processor 510 in accordance with instructions stored as applications software in the memory 504 and/or input commands received from a user via the user controls 514.

However, it will be appreciated that the above described configuration assumed for the purpose of the following examples is not essential, and numerous other configurations may be used. It will also be appreciated that the partitioning of functionality between the different processing systems may vary, depending on the particular implementation.

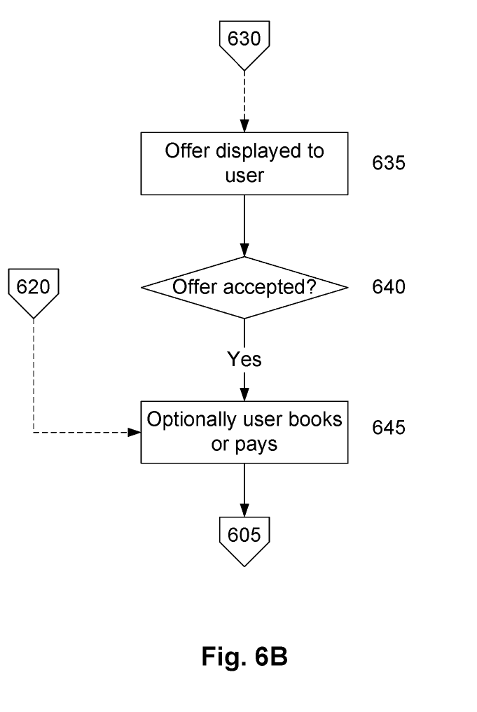

A further example of a method for monitoring user transactions and providing recommendations will now be described with reference to FIGS. 6A and 6B. In this example, functionality may be largely provided using a user application (or “App”) which is executed on a user device 230 and a merchant App operating on the merchant device 220, both Apps being in communication with a server 210. However, as discussed above, this is not essential and numerous other configurations are envisaged.

In this example, at step 600, the server 210 receives transaction data indicative of a user paying a bill and/or making a booking with a merchant. Typically, this involves the user utilising the user App on their user device 230 to complete the transaction, and the user App communicating the transaction data to the server 210 via a communication network 240. However, this may be achieved in any other suitable manner, for example with the user presenting an account card, such as a credit or debit card, to a merchant terminal 220 or by utilising an online payment application, other application, or digital wallet associated with the user device 230. The server 210 then receives the transaction data from either the merchant terminal or user device 230.

At step 605, the server 210 determines a type associated with the transaction data. This typically includes determining the type of merchant associated with the transaction, or the type(s) of products or services that the user purchased/booked. This may be achieved in any suitable manner, and can include using the merchant or item to look up the merchant or item type in a store or database 211 of the server 210. For example, the database 211 may include a list of merchants and items and their corresponding type(s). Such a database may be maintained and updated in any suitable manner, for example, using merchant or administrator input commands and this will be discussed further below.

At step 610, the location of the user is determined. Typically this is done using geolocation functions associated with the user device 230. As geolocation techniques are known in the art, they will not be discussed in further detail here.

A recommendation including recommended merchants is identified at step 615 by the relationship assessment engine 305 of the server 210, as per the recommendation defined in an earlier portion of the description. This is achieved, for example, using the identified type at step 605 and the location of the user at 610. In this regard, relationship data is used to determined which type of merchant is likely to be required after the identified type, and the user location is used to determined which of the recommended types of merchants are nearby. The relationship data has also been defined in an earlier portion of the description, At step 620, these nearby merchants are then notified to the use at the user device 230r, which can involve providing the notification to the user via the user App. Optionally, the user may also be notified of each merchants' items or specialities via the user App.

Optionally, the merchants which have been recommended to the user at the user device 230 at step 620 are also notified at step 625, such as via a communications network 240 to the merchant App operating on the merchant device 220. This provides the recommended merchants an opportunity to identify any offers or promotions which they may wish to provide to the user in order to entice them to make a booking or purchase at step 630. In this regard, the merchant may wish to dynamically create an offer at the merchant device 220 at step 630, for example, by inputting a price promotion on one or more of their products or services, into the merchant App.

At step 635 the offer is displayed to the user at the user device 230 via the user App, and the user may accept the offer at step 640, for example, by inputting commands using a touchscreen on their device 230.

At step 645, the user may use the user device 230 to browse the recommended merchants (and optionally their corresponding offers) and optionally book with one or more of the recommended merchants and make a payment or prepayment toward products or services offered by that merchant. As will be appreciated, this may be in response to the offer made, or may simply be in response to the recommendation at step 620. The user uses the user App to complete the booking or payment accordingly. Consequently, the booking or payment at step 645 may form a further transaction from which a further recommendation may be made commencing at step 605.

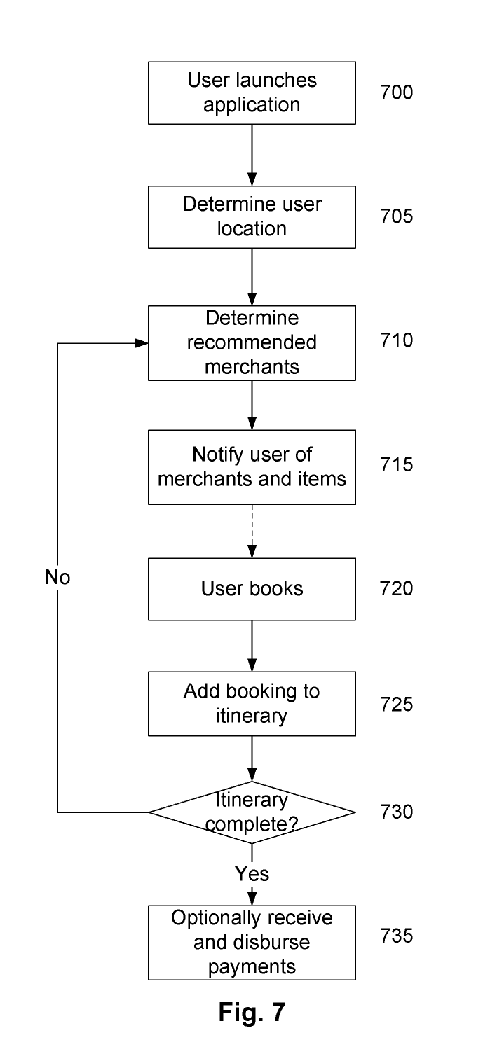

A further example of a method for monitoring user transactions and providing recommendations will now be described with reference to FIG. 7. In this example, functionality may be largely provided using a user application (or “App”) which is executed on a user device 230 and a merchant App operating on the merchant device 220, both Apps being in communication with a server 210. However, as discussed above, this is not essential and numerous other configurations are envisaged.

In this example, the user launches the user App on their user device 230. The location of the user is determined at step 705 using geolocation associated with the user device 230, and this is communicated to the server 210 via a communications network. At this step, using the user App, the user may also indicate a preference for a type of merchant or item which is also communicated to the server 210.

At step 710, the server 210 uses the location, and optionally type preference, to retrieve a number of nearby merchants and their products/services or specialities. This is communicated to the user device 230 and displayed to the user using the user App at step 715.

The user then uses the user device 230 for browsing the recommendations and makes a selection for which they optionally make a booking and advance payment at step 720 using the user App. The booking and/or payment is added to an itinerary for the user at step 725, and this transaction is then used to make further recommendations of linked merchants and their items, specialities or offers from step 710. In this regard, the user is able to extend their itinerary by included other linked purchases or bookings, until they are satisfied that the itinerary is complete at step 730.

Optionally, rather than collecting a payment with each booking at step 720, the user may instead reserve payment until multiple bookings are complete within their itinerary and then proceed with a single payment for multiple bookings, and hence multiple merchants, at step 735. In this regard, the user App may be used to accept the user's payment at 735, which is communicated to the server, and subsequently the payment is disbursed among each merchant associated with the payment by the server 210. The outcome of the disbursement is then communicated to the merchant device via the merchant App.

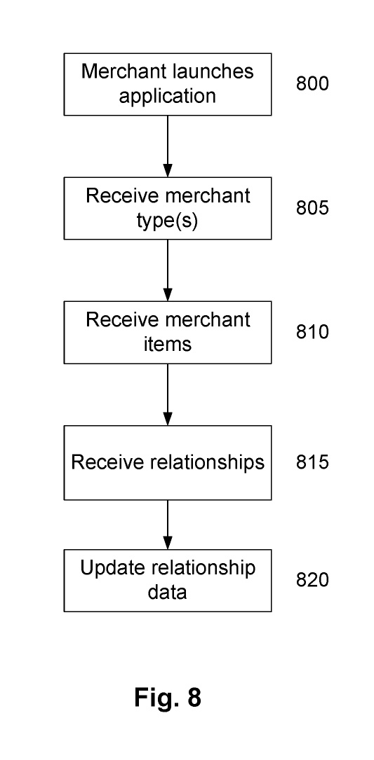

A further example of a method for monitoring user transactions and providing recommendations will now be described with reference to FIG. 8. In this example, functionality may be largely provided using a merchant application (or “App”) which is executed on a merchant device 220 in communication with a server 210. However, as discussed above, this is not essential and numerous other configurations are envisaged.

In this example, the merchant may optionally enrol form the merchant App and create a corresponding profile at step 800. In this regard, the profile may include any suitable information, such as location, name, image, logo, or the like, which is communication with the server 810.

The merchant uses the merchant App to specify their type or types. As discussed above, types may include any suitable category such as desserts, beverages, starters, or the like. Accordingly, information including the merchant type (or types) may be communicated to the server 210 at step 805 via a communications network.

The merchant App is also used by the merchant to specify their items, including products and services, specialities, menu items, or the like. The items are provided to the server 210 by the App at step 810.

The merchant App is also operable to accept relationships as input from the merchant. In this regard, the merchant is able to select dependencies or links among their items, item types and merchant types. For example, the merchant can specify items which they offer as a main course are followed by desserts and preceded by starters. The relationships are communicated with the server 210 at step 815.

Accordingly, at step 820, the server 210 updates relationship data using the information provided at step 815. This may be achieved in any suitable manner, for example, by incorporating the merchant-defined relationships into relationship data stored in the database 211.

Accordingly, the above describes systems and processes for monitoring user transactions and making recommendations, where the recommendations are based upon relationship data between merchants, items or types thereof. There are numerous advantages to this approach, including ensuring the user is presented with relevant related recommendations, thus saving time and effort otherwise expended in researching appropriate activities or products. Moreover, merchants benefit from such a system by ensuring their marketing and promotional activities are constrained to target appropriate users.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described. Thus, for example, it will be appreciated that features from different examples above may be used interchangeably where appropriate.

The claims defining the invention are as follows:

1) A method for monitoring user transactions and providing recommendations, the method including, in one or more electronic processing devices:
a) receiving, at a relationship assessment engine, transaction data indicative of transaction details regarding a transaction between a user and a merchant, the transaction details being indicative of at least one of:
i) a merchant identity of the merchant;
ii) a merchant type associated with the merchant;
iii) an item associated with the transaction; and,
iv) an item type associated with the transaction;
b) retrieving, from the relationship assessment engine, at least one recommendation from relationship data using the transaction details, the relationship data being indicative of a plurality of recommendations, each recommendation being related to at least one of:
i) at least one merchant identity;
ii) at least one merchant type;
iii) at least one item type; and,
iv) at least one item; and,
c) causing, at a user device, a recommendation indication indicative of at least one recommendation to be displayed to the user, thereby allowing the user to selectively perform at least one transaction relating to the at least one recommendation,
wherein the relationship data is in a form of either a map of linkages or a look-up table.

2) A method according to claim 1, wherein the method includes, in the one or more electronic processing devices, receiving the transaction data from a transaction device via a communications network.

3) A method according to claim 2, wherein the method includes, in the one or more electronic processing devices:
a) generating a recommendation message, the recommendation message being indicative of at least one recommendation;
b) providing the recommendation message to the transaction device, the transaction device being responsive to the recommendation message to:
i) display a recommendation indication indicative of at least one recommendation;
ii) determine user acceptance of a recommendation in accordance with user input commands;
iii) generate an acceptance message; and,
iv) provide the acceptance message to the one or more electronic processing devices;
c) receive the acceptance message; and,
d) in accordance with the acceptance message, at least one of:
i) causing a booking to be made;
ii) causing the recommendation to be acquired; and,
iii) performing a transaction relating to the recommendation.

4) A method according to claim 3, wherein the method includes, in the one or more electronic processing device, causing the booking to be made by providing a booking notification indicative of the booking to a merchant device of a merchant associated with the booking.

5) A method according to claim 3, wherein the transaction device includes at least one of the user device and a transaction terminal.

6) A method according to claim 1, wherein the recommendation is indicative of at least one of:
a) at least one merchant identity;
b) at least one merchant type;
c) at least one item type; and,
d) at least one item.

7) A method according to claim 1, wherein the relationship data is indicative of at least one of a merchant type and an item type, and wherein the method includes, in the one or more electronic processing devices, determining the recommendation by at least one of:
a) determining a plurality of merchants using the merchant type; and,
b) determining a plurality of items using the item type.

8) A method according to claim 1, wherein the method includes, in the one or more electronic processing device:
a) determining location data indicative of a location of at least one of the user device and the merchant device; and,
b) determining the at least one recommendation using the location data.

9) A method according to claim 8, wherein the method includes, in the one or more electronic processing device:
a) determining a search vicinity using the location data; and,
b) determining the recommendation at least partially using the search vicinity.

10) A method according to claim 9, wherein the method includes, in the one or more electronic processing device, determining the recommendation by selecting a plurality of merchants using the search vicinity and a merchant type defined in the relationship data.

11) A method according to claim 1, wherein the relationship data is indicative of sequences of relationships.

12) A method according to claim 2, wherein the recommendation indication is indicative of a sequence of recommendations and wherein the transaction device:
a) determines acceptance of a plurality of recommendations in the sequence of recommendations in accordance with user input commands;
b) generates one or more acceptance messages indicative of a sequence of acceptances; and,
c) provides the one or more acceptance messages to the electronic processing device, the electronic processing device being responsive to the one or more acceptance messages to at least one of:
i) cause a sequence of bookings to be made;
ii) cause at least one of the sequence of recommendations to be acquired; and,
iii) perform at least one transaction relating to the sequence of acceptances.

13) A method according to claim 12, wherein the method includes, in the one or more electronic processing device:
a) generating an itinerary indicative of a sequence of acceptances; and,
b) causing an indication of the itinerary to be displayed to the user.

14) A method according to claim 11, wherein the method includes, in the one or more electronic processing device causing a payment to be performed in respect of multiple acceptances in accordance with one or more acceptance messages.

15) A method according to claim 14, wherein the multiple recommendations are associated with a number of merchants, and wherein the method includes, in the one or more electronic processing device:
a) causing an account of the user to be debited in accordance with payment details of the payment;
b) causing an account of each of the merchants associated with a corresponding one of the sequence of acceptances to be credited in accordance with the payment details; and,
c) causing an indication of an outcome of the payment to be displayed to at least one of the user and the merchants.

16) A method according to claim 1, wherein the method includes, in the one or more electronic processing device:
a) generating a merchant notification indicative of a recommendation;
b) providing the merchant notification to a merchant device of a recommended merchant associated with the recommendation, the merchant device being responsive to the merchant notification to:
i) determine an offer in accordance with the recommendation;
ii) generate an offer notification; and,
iii) provide an offer notification to the electronic processing device;
c) receiving the offer notification indicative of the offer; and,
d) causing an indication of the offer to be displayed to the user in accordance with the recommendation.

17) A method according to claim 1, wherein the method includes, in the one or more electronic processing devices:
a) generating an offer message, the offer message being indicative of at least one offer;
b) providing the offer message to a transaction device, the transaction device being responsive to the offer message to:
i) display an offer indication indicative of at least one offer;
ii) determine user acceptance of at least one offer in accordance with user input commands;
iii) generate an offer acceptance message; and,
iv) provide the offer acceptance message to the one or more electronic processing devices;
c) receiving the offer acceptance message; and,
d) notifying the merchant of the offer acceptance, thereby allowing the user to redeem the offer.

18) A method according to claim 16, wherein the method includes, in the merchant device, at least one of:
a) determining the offer from offer data; and,
b) displaying an indication of the recommendation and determining the offer in accordance with merchant input commands.

19) A method according to claim 1, the at least one relationship being determined using at least one of:
a) previous transaction details;
b) reference relationships;
c) merchant input commands; and,
d) user input commands.

20) A method according to claim 1, wherein the method includes, in the one or more electronic processing device, updating the relationship data using the transaction details.

21) A system for monitoring user transactions and providing recommendations, the system including one or more electronic processing devices that:
a) receives, at a relationship assessment engine, a bill indicative of transaction details regarding a transaction between a user and a merchant, the bill being indicative of at least one of:
i) a merchant identity of the merchant;
ii) a merchant type associated with the merchant;
iii) an item associated with the transaction; and,
iv) an item type associated with the transaction;
b) retrieves, at the relationship assessment engine, at least one recommendation from relationship data using the transaction details, the relationship data being indicative of a plurality of recommendations, each recommendation being related to at least one of:
i) at least one merchant identity;
ii) at least one merchant type;
iii) at least one item type; and,
iv) at least one item; and,
c) causes, at a user device an indication of the at least one recommendation to be displayed to the user, thereby allowing the user to selectively perform at least one transaction relating to the at least one recommendation,
wherein the relationship data is in a form of either a map of linkages or a look-up table.
